(19) United States
(12) Patent Application Publication
(10) Pub. No.: US 2023/0194248 A1
(43) Pub. Date: Jun. 22, 2023

(54) Three-Dimensional Measurement System

(71) Applicant: Nippon Telegraph and Telephone Corporation, Tokyo (JP)

(72) Inventors: Kei Watanabe, Tokyo (JP); Yu Kurata, Tokyo (JP)

(21) Appl. No.: 17/996,016

(22) PCT Filed: May 12, 2020
(86) PCT No.: PCT/JP2020/018940

§ 371 Date: Oct. 12, 2022

(51) Int. Cl. G01B 11/25

(52) U.S. Cl. CPC G01B 11/2527; G01B 11/254

(57) ABSTRACT

An embodiment is a three-dimensional measurement system including a projection device configured to generate a fringe pattern by interference between two light beams and project the fringe pattern onto an object, and a mobile terminal, wherein the projection device includes a fringe generation unit composed of a planar lightwave circuit including a phase modulator, the fringe generation unit being configured to generate the fringe pattern, and a phase control unit configured to control the phase modulator and change a phase of the fringe pattern, wherein the mobile terminal includes a camera configured to perform image-taking of the object, the fringe pattern being projected onto the object, and an image analysis unit configured to analyze a plurality of images which are taken by the camera and are different in the phase of the fringe pattern and calculate three-dimensional shape data of the object.

### CROSS-REFERENCE TO RELATED APPLICATIONS

This application is a national phase entry of PCT Application No. PCT/JP2020/018940, filed on May 12, 2020, which application is hereby incorporated herein by reference.

### TECHNICAL FIELD

The present invention relates to a three-dimensional measurement system for measuring a three-dimensional shape of an object by a phase shift method, and particularly to a three-dimensional measurement system which is small-sized and excellent in portability and is capable of stable measurement.

### BACKGROUND

With the development of 3D printers in recent years, methods of manufacturing are undergoing a great change. Detailed examination of three-dimensional information of an object is important to use a 3D printer, and attention is being given to three-dimensional measurement technology. There is a great need for three-dimensional measurement at a manufacturing site, such as inspection for asperities of a vehicle body or the like.

Personal authentication technology for unlocking a smartphone through image recognition or allowing operation of an ATM (Automatic Teller Machine) has been receiving attention in recent years. In the field of personal authentication, there is a move to simultaneously acquire three-dimensional measurement data of a person as countermeasures against third-party spoofing.

One of methods for measuring a three-dimensional shape of an object in a non-contact manner is a phase shift method. The phase shift method is a method that projects a fringe pattern, light intensity of which is spatially sinusoidal, onto an object to be measured, shifts an optical phase at least three times, and performs image-taking of the object from an angle different from a projection direction, thereby calculating phase values of the projected pattern and obtaining a surface shape of the object from the phase values. The phase shift method is a method capable of measuring the amount of heightwise displacement of a shape (displacement) of an object at each measurement point of an image sensor and obtaining a three-dimensional shape.

A phase shift method causes two light beams to interfere with each other and projects a fringe pattern onto an object to be measured. To cause interference between two light beams, a phase shift mechanism for changing an optical phase is provided in one of two optical paths. An optical system used by the phase shift method usually adopts a configuration as in FIG. 28.

Light output from a laser 1000 is divided to have two optical paths by a half mirror 1001 with a transmittance of 50%. One of light rays obtained through the division by the half mirror 1001 is reflected by a mirror 1002, is further reflected by the half mirror 1001, is collected by a lens 1003, and enters an object 1010.

The other light ray obtained through the division by the half mirror 1001 enters a mirror 1004 having a mechanical displacement mechanism 1005, such as a piezoelectric element, is reflected by the mirror 1004, passes through the half mirror 1001 and the lens 1003, and enters the object 1010. Reflected light from the object 1010 passes through a lens 1006 and enters a CCD 1007.

An optical path length of the other light ray is changed by displacing the mirror 1004 with the displacement mechanism 1005. The change in the optical path length causes interference between the two light rays, and a fringe pattern is projected onto the object 1010. When a position of the mirror 1004 is changed, fringes move due to interference.

The amount of fringe pattern displacement on the object 1010 can be obtained by image-taking of respective fringe patterns with different phases with the CCD 1007 and calculating, for each pixel of the CCD 1007, the phases of the image-taken fringe patterns. Finally, a three-dimensional shape of the object 1010 can be obtained.

As shown in FIG. 28, an optical system used in a conventional phase shift method is a combination of simplex optical components and suffers the problems of a complicated configuration, a large number of components, a large size of the entire unit, and inferior portability.

Patent Literature 1 discloses a method for miniaturizing an optical system. A configuration disclosed in Patent Literature 1, however, is not different from the configuration in FIG. 28 in that simplex optical components are combined, and there is a limit on miniaturization of an optical system. The configuration disclosed in Patent Literature 1 suffers the problems of a lack of stability due to presence of a movable unit composed of a piezoelectric element and a change in state over time.

As a configuration aimed at further miniaturization of an optical system, a configuration using optical fibers is disclosed in Non-Patent Literature 1. In the configuration disclosed in Non-Patent Literature 1, light output from a laser is branched into two by a splitter, and branched light rays are applied to an object via respective fibers. Optical phase shifting is implemented by a variable wavelength plate which is provided at one of the fibers.

In the case of the configuration disclosed in Non-Patent Literature 1, if standard ones are used as fibers, a diameter including a jacket (coating) is less than 1 mm. Use of two fibers requires only a width of about 2 mm, which allows miniaturization of an optical system. The configuration disclosed in Non-Patent Literature 1, however, suffers a situation where two optical path lengths fluctuate unintentionally due to movement of the fibers after a splitter to prevent stable measurement.

As a method aimed at miniaturization and curbing of reduction in measurement accuracy, there is available a method using a planar lightwave circuit as disclosed in Patent Literature 2. The use of the planar lightwave circuit allows integration of a Y branching splitter and a phase modulator and implementation of stable projection of fringes and phase control with just several millimeters. In the configuration disclosed in Patent Literature 2, a small-sized camera which performs image-taking of an object is fixed to the planar lightwave circuit and is electrically connected to a wiring portion of the planar lightwave circuit.

However, a conceivable field of use for the configuration disclosed in Patent Literature 2 is an endoscope or the like. Since a longitudinal size of a fiber is about several meters in the configurations disclosed in Non-Patent Literature 1 and Patent Literature 2, the configurations are inevitably said to be lacking in portability and stability.

### CITATION LIST

### Patent Literature

Patent Literature 1: Japanese Patent No. 5761786

Patent Literature 2: Japanese Patent Laid-Open No. 2018-119865

### Non-Patent Literature

Non-Patent Literature 1: Silvio Pulwer, P. Steglich, C. Villringer, J. Bauer, T. Reusch, and S. Schrader, “Fiber-optic interference fringe projection for 3D measurement,” DGaO-Proceedings, 2016, <https://www.dgao-proceedings.de/download/117/117_p23.pdf>

### SUMMARY

### Technical Problem

The present invention has been made to solve the above-described problems, and has as its object to provide a three-dimensional measurement system which is small-sized and excellent in portability and is capable of stable measurement.

### Means for Solving the Problem

A three-dimensional measurement system according to embodiments of the present invention includes a projection device configured to generate a fringe pattern by interference between two light beams and project the fringe pattern onto an object, and a mobile terminal, the projection device includes a fringe generation unit composed of a planar lightwave circuit including a phase modulator, the fringe generation unit being configured to generate the fringe pattern, and a phase control unit configured to control the phase modulator and change a phase of the fringe pattern, and the mobile terminal includes a camera configured to perform image-taking of the object, the fringe pattern being projected, and an image analysis unit configured to analyze a plurality of images which are taken by the camera and are different in the phase of the fringe pattern and calculate three-dimensional shape data of the object.

In some embodiments of the three-dimensional measurement system according to the present invention, the fringe generation unit includes a light source, an input waveguide coupled to an output of the light source, a Y branching waveguide connected to the input waveguide, the Y branching waveguide being configured to branch light into two, two output waveguides connected to respective outputs of the Y branching waveguide, and two phase modulators, each phase modulator being identical to the phase modulator, the two phase modulators being provided at the two output waveguides respectively, the two phase modulators being configured to modulate phases of light rays propagating through the two output waveguides.

In some embodiments of the three-dimensional measurement system according to the present invention, the input waveguide is bent in a middle such that an angle of inclination of a direction of emergence of light from the output waveguides with respect to a direction of incidence of light from the light source to the input waveguide is not less than 30 degrees.

Some embodiments of the three-dimensional measurement system according to the present invention further includes a clip-shaped fixture that holds the mobile terminal, the projection device is fixed to the fixture, and the fixture includes an alignment structure for determining a position of an exit port for the two light beams of the projection device relative to the camera of the mobile terminal.

In some embodiments of the three-dimensional measurement system according to the present invention, the alignment structure is composed of a transparent plate disposed at the fixture so as to cover a light-receiving surface of the camera of the mobile terminal when the fixture is attached to the mobile terminal, and a scale formed on the transparent plate.

A three-dimensional measurement system according to embodiments of the present invention includes a projection device configured to generate a fringe pattern by interference between two light beams and project the fringe pattern onto an object, and a mobile terminal, the projection device includes a fringe generation unit composed of a planar lightwave circuit including a phase modulator, the fringe generation unit being configured to generate the fringe pattern, a phase control unit configured to control the phase modulator and change a phase of the fringe pattern, a camera configured to perform image-taking of the object, the fringe pattern being projected onto the object, a first communication unit configured to transmit an image taken by the camera to the mobile terminal, and a first connector for communication with the mobile terminal, the mobile terminal includes a second communication unit configured to receive the image from the projection device, an image analysis unit configured to analyze a plurality of images which are taken by the camera of the projection device and are different in the phase of the fringe pattern and calculate three-dimensional shape data of the object, and a second connector for communication with the projection device, and the projection device is attached to the mobile terminal by fitting together of the first connector and the second connector.

In some embodiments of the three-dimensional measurement system according to the present invention, the fringe generation unit includes a light source, an input waveguide coupled to an output of the light source, a Y branching waveguide connected to the input waveguide, the Y branching waveguide being configured to branch light into two, two output waveguides connected to respective outputs of the Y branching waveguide, and two phase modulators, each phase modulator being identical to the phase modulator, the two phase modulators being provided at the two output waveguides respectively, the two phase modulators being configured to modulate phases of light rays propagating through the two output waveguides.

In some embodiments of the three-dimensional measurement system according to the present invention, the input waveguide is bent in a middle such that an angle of inclination of a direction of emergence of light from the output waveguides with respect to a direction of incidence of light from the light source to the input waveguide is not less than 30 degrees.

### Effects of the Invention

According to embodiments of the present invention, a three-dimensional measurement system which is small-sized and excellent in portability and is capable of stable measurement can be implemented by providing, in a projection device, a fringe generation unit composed of a planar lightwave circuit including a phase modulator and a phase control unit and providing, in a mobile terminal, a camera and an image analysis unit.

The embodiments of the present invention allow implementation of a three-dimensional measurement system which is small-sized and excellent in portability and is capable of stable measurement by providing a fringe generation unit composed of a planar lightwave circuit including a phase modulator, a phase control unit, a camera, a first communication unit, and a first connector and providing, in a mobile terminal, a second communication unit, an image analysis unit, and a second connector. The embodiments of the present invention makes it possible to keep a distance between an exit port for two light beams of the projection device and a center of a light-receiving surface of the camera constant.

### BRIEF DESCRIPTION OF THE DRAWINGS

FIG. 1 is a perspective view of a planar lightwave circuit according to a first embodiment of the present invention.

FIG. 2 is a plan view of the planar lightwave circuit according to the first embodiment of the present invention.

FIG. 3 is a perspective view of a semiconductor laser according to the first embodiment of the present invention.

FIG. 4 is a perspective view for explaining a method for fixing the semiconductor laser to a subcarrier in the first embodiment of the present invention.

FIG. 5 is a plan view showing a state where the semiconductor laser is fixed to the subcarrier in the first embodiment of the present invention.

FIG. 6 is a plan view showing another example where the semiconductor laser is fixed to the subcarrier in the first embodiment of the present invention.

FIG. 7 is a perspective view for explaining a method for coupling the semiconductor laser and a fringe generation unit together in the first embodiment of the present invention.

FIG. 8 is a plan view showing a state where the semiconductor laser and the fringe generation unit are coupled together in the first embodiment of the present invention.

FIG. 9 is a plan view showing a junction of the semiconductor laser and the fringe generation unit in the first embodiment of the present invention.

FIG. 10 is a perspective view for explaining a method for fixing the subcarrier and the fringe generation unit to a ceramic housing in the first embodiment of the present invention.

FIG. 11 is a sectional view showing a state where the subcarrier and the fringe generation unit are housed in the ceramic housing in the first embodiment of the present invention.

FIG. 12 is a plan view showing the state where the subcarrier and the fringe generation unit are housed in the ceramic housing in the first embodiment of the present invention.

FIG. 13 is a block diagram showing a configuration which controls a fringe generation optical module according to the first embodiment of the present invention.

FIG. 14 is a perspective view showing an outer appearance of a projection device according to the first embodiment of the present invention.

FIG. 15 is an exploded perspective view showing an internal configuration of the projection device according to the first embodiment of the present invention.

FIG. 16 is a block diagram showing a configuration of a mobile terminal according to the first embodiment of the present invention.

FIG. 17 is a perspective view for explaining a method for attaching the projection device to the mobile terminal according to the first embodiment of the present invention.

FIG. 18 is a perspective view for explaining the method for attaching the projection device to the mobile terminal according to the first embodiment of the present invention.

FIG. 19 is a front view showing a state where the projection device according to the first embodiment of the present invention is attached to the mobile terminal.

FIG. 20 is a flowchart for explaining a three-dimensional measurement method according to the first embodiment of the present invention.

FIG. 21 is a perspective view showing an outer appearance of a projection device according to a second embodiment of the present invention.

FIG. 22 is a block diagram showing a configuration of the projection device according to the second embodiment of the present invention.

FIG. 23 is a perspective view for explaining a method for attaching the projection device according to the second embodiment of the present invention to a mobile terminal.

FIG. 24 is a flowchart for explaining a three-dimensional measurement method according to the second embodiment of the present invention.

FIG. 25 is a block diagram showing a configuration of a server device according to a third embodiment of the present invention.

FIG. 26 is a flowchart for explaining a three-dimensional measurement method according to the third embodiment of the present invention.

FIG. 27 is a plan view showing a state where a semiconductor laser and a fringe generation unit are coupled together in a fourth embodiment of the present invention.

FIG. 28 is a block diagram showing a configuration of an optical system used by a conventional phase shift method.

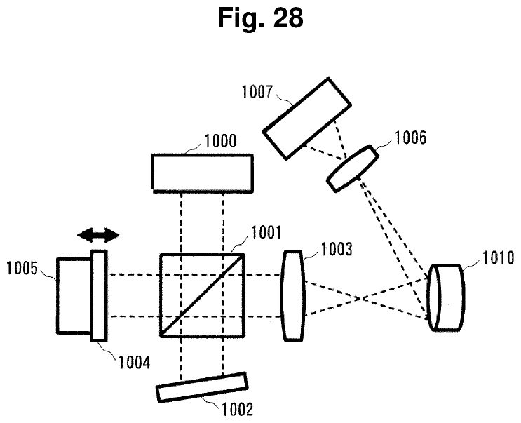

### DETAILED DESCRIPTION OF ILLUSTRATIVE EMBODIMENTS

### First Embodiment

An embodiment of the present invention will be described below with reference to drawings. The present embodiment provides a portable three-dimensional measurement system which is capable of implementing three-dimensional measurement of an object by a phase shift method, using a projection device which generates a fringe pattern due to interference between two light beams and projects the fringe pattern onto an object and a mobile terminal including a camera.

Specifically, the projection device is composed of a planar lightwave circuit (PLC) including a phase modulator and includes a fringe generation unit which generates a fringe pattern and a phase control unit which controls the phase modulator to change a phase of the fringe pattern. The mobile terminal includes a camera which performs image-taking of an object, onto which a fringe pattern is projected, and an image analysis unit which analyzes a plurality of images taken by the camera and different in the phase of the fringe pattern and calculates three-dimensional shape data of the object.

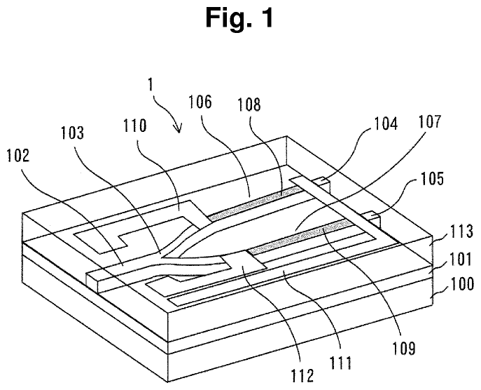

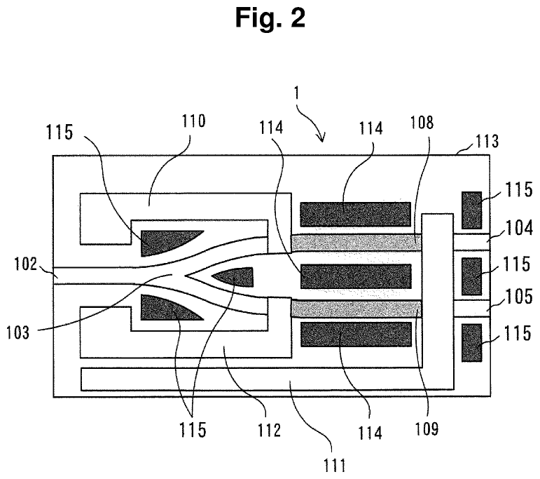

First, the fringe generation unit composed of the PLC will be described. FIG. 1 is a perspective view of a fringe generation unit 1, and FIG. 2 is a plan view of the fringe generation unit 1. Note that an interior of an overcladding is illustrated in a see-through manner in FIGS. 1 and 2.

In the fringe generation unit 1, an input waveguide 102 which is to be coupled to a semiconductor laser (not shown), a Y branching waveguide 103 which is connected to the input waveguide 102 and branches light into two, two output waveguides 104 and 105 which are connected to respective outputs of the Y branching waveguide 103, and phase modulators 106 and 107 which modulate phases of light rays propagating through the two output waveguides 104 and 105 are formed on an undercladding 101 which is formed on a silicon substrate 100.

The phase modulators 106 and 107 are composed of heaters 108 and 109 made of respective conductors which are formed directly on the output waveguides 104 and 105. When a voltage is fed to the heater 108 via a heater pad no made of a conductor which is connected to one end of the heater 108 and a ground pad in made of a conductor which is connected to the other end of the heater 108, the heater 108 generates heat.

Similarly, when a voltage is fed to the heater 109 via a heater pad 112 made of a conductor which is connected to one end of the heater 109 and the ground pad 111 that is connected to the other end of the heater 109, the heater 109 generates heat.

When the heaters 108 and 109 are made to generate heat, as described above, to heat the output waveguides 104 and 105, phases of light rays propagating through the output waveguides 104 and 105 can be phase-modulated by the thermooptical effect.

A chip size of the fringe generation unit 1 is 0.8 mm (W)×4 mm (L). Lengths of the heaters 108 and 109 of the phase modulators 106 and 107 are set at 1.5 mm. Note that a configuration of the fringe generation unit 1 is schematically illustrated in FIGS. 1 and 2 and that dimensions are exaggerated.

A specific manufacturing method for the fringe generation unit 1 will be described. Quartz glass containing GeO₂ and having a thickness of 3 μm is deposited on the undercladding 101 made of a 10-μm-thick thermal oxide film which is formed on the silicon substrate 100, using a FHD (Flame Hydrolysis Deposition) method. A dopant amount of GeO₂ is adjusted such that a relative refractive index of a core is 0.5%.

Shapes of the waveguides 102 to 105 are formed using general photolithography and reactive ion etching. The FHD method is used again to form an overcladding 113.

The heaters 108 and 109 that are 350 nm thick and made of Cr (chromium) are evaporated onto the overcladding 113 at positions directly on the output waveguides 104 and 105 by a lift-off method. To efficiently make the thermooptical effect apparent, heat-insulating grooves 114 are formed in the overcladding 113 and the undercladding 101, as shown in FIG. 2.

Light-shielding grooves 115 are formed in the overcladding 113 and the undercladding 101 so as to prevent, as far as possible, light left uncoupled or stray light generated due to a coupler loss from appearing at exit ports of the output waveguides 104 and 105 when the semiconductor laser is coupled to the input waveguide 102. Note that the heat-insulating grooves 114 and the light-shielding grooves 115 are not shown in FIG. 1 for the sake of brevity. The heat-insulating grooves 114 and the light-shielding grooves 115 are not shown in subsequent drawings.

Under ordinary circumstances, a fringe pattern, intensity of which is modulated in a spatially sinusoidal manner by interference between two light beams, is obtained. However, if stray light is emitted to a space through the exit ports of the output waveguides 104 and 105, unexpected interference occurs, interference fringes in which a fringe pattern with a different period is further superimposed on the original fringe pattern are projected onto an object. This results in increase in a measurement error at the time of image analysis and calculation of three-dimensional data of the object.

Since the above-described measurement error can be corrected to a certain degree by software, the light-shielding grooves 115 are not necessarily required. However, to measure a three-dimensional shape of an object with higher accuracy, countermeasures against stray light are important.

Although GeO₂ is used as a core dopant in the present embodiment, any other dopant may be adopted. Alternatively, a waveguide may be formed by using pure quartz as a core and glass doped with boron or fluorine as a cladding.

A quartz-based waveguide is a waveguide widely used in the field of optical communication, and stability, long-term reliability, and mass productivity are easily achieved. Additionally, the quartz-based waveguide is transparent to a visible range. For this reason, the quartz-based waveguide has the advantages that an inexpensive camera can be used and that an inexpensive semiconductor laser in widespread use in, e.g., a DVD (Digital Versatile Disc) player can be used.

It will be appreciated that a material for a waveguide is not limited to quartz. A waveguide may be formed of, e.g., a crystalline material. The heaters 108 and 109 may be made of a metal other than chromium. For example, in a case where a waveguide made of silicon is used, the waveguide is transparent to light, a wavelength of which is longer than 1200 nm, and the same effects as a quartz-based waveguide according to the present embodiment are obtained. A waveguide made of silicon can be used instead of the waveguide according to the present embodiment in principle. However, the waveguide made of silicon is opaque to the visible range. For this reason, an inexpensive camera cannot be used, and a device becomes a very high-grade one.

In the present embodiment, the phase modulators 106 and 107 composed of the heaters 108 and 109 are used. If a crystalline material is used for a waveguide, an optical phase can be modulated using an electrooptical effect besides the thermooptical effect.

If the electrooptical effect is used, although current flows at the moment when an electric field is applied to crystals, current does not flow all the time. This allows reduction in power consumption. An example of a waveguide using a crystalline material is a LiNbO₃ waveguide. Note that a waveguide using a crystalline material is higher in material cost than quartz.

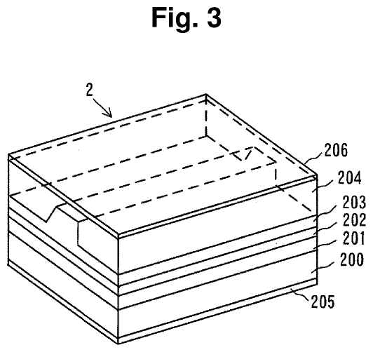

A semiconductor laser serving as a light source will be described. FIG. 3 is a perspective view of a semiconductor laser 2. In the semiconductor laser 2, an n-type AlGaInP cladding layer 201, an active layer 202 which is composed of an MQW (Multiple Quantum Well), a p-type AlGaInP cladding layer 203, and an n-type AlInP block layer 204 are stacked in order on an n-type GaAs substrate 200.

An upper-layer portion of the p-type AlGaInP cladding layer 203 has a ridge stripe shape extending in one direction. An n-side electrode 205 is formed on a reverse side of the n-type GaAs substrate 200. A p-side electrode 206 is formed on the n-type AlInP block layer 204.

The semiconductor laser 2 oscillates at wavelengths in the 650 nm band and is widely used as a generally known light source for a DVD. The semiconductor laser 2 is commercially available and is easily available. Although compositions and structures differ by manufacturer, it is self-evident that differences in a structure of the semiconductor laser 2 do not matter in the embodiments of the present invention and that any other structure may be adopted.

As the semiconductor laser 2 for visible light, one which emits up to light in a near-infrared region is commercially available, and a wavelength need not be in the 650 nm band. A material for the semiconductor laser 2 is not limited to the above-described example. Since many of image sensors are made of silicon, the semiconductor laser 2 can be inexpensively manufactured as long as the wavelength is a wavelength which achieves sensitivity enough for an image sensor.

If an image sensor made of a compound semiconductor is used, an oscillation wavelength of the semiconductor laser 2 may exceed 1 μm. In a case using the semiconductor laser 2, an oscillation wavelength of which exceeds 1 μm, selection of, e.g., an eye-safe one (a wavelength safe for the human eye) brings the advantage that a human face can be safely measured with eyes open.

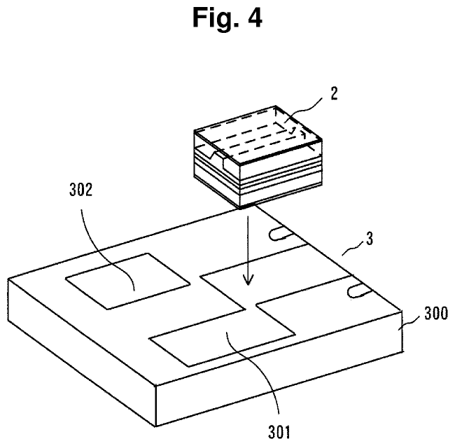

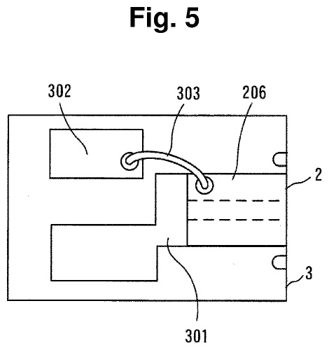

FIG. 4 is a perspective view for explaining a method for fixing the semiconductor laser 2 to a subcarrier 3, and FIG. 5 is a plan view showing a state where the semiconductor laser 2 is fixed to the subcarrier 3.

The subcarrier 3 is composed of a silicon substrate 300 having a 100-nm-thick thermal oxide film at a surface. An n-side electrode pad 301 and a p-side electrode pad 302 are formed on the thermal oxide film.

As shown in FIGS. 4 and 5, the semiconductor laser 2 is mounted on the n-side electrode pad 301 of the subcarrier 3 such that the n-side electrode pad 301 and the n-side electrode 205 are in contact. The p-side electrode pad 302 of the subcarrier 3 and the p-side electrode 206 of the semiconductor laser 2 are connected by a wire 303.

In the present embodiment, the semiconductor laser 2 and the subcarrier 3 are fixed together using a solder sheet. Fixation with a conductive paste or the like may be adopted as long as conduction between the n-side electrode pad 301 of the subcarrier 3 and the n-side electrode 205 of the semiconductor laser 2 is possible.

In the example in FIG. 5, fixation is performed such that positions of an exit end (a right end in FIG. 5) of the semiconductor laser 2 and an end of the subcarrier 3 are the same. In an actual manufacturing process, fixation is performed after checking positions with a camera and aligning ends at the time of mounting. The exit end of the semiconductor laser 2 may be separated from the end of the subcarrier 3 by a distance of 10 μm or shorter. Note that alignment of the end of the subcarrier 3 with the exit end of the semiconductor laser 2 is preferable because the same coupling is easily achievable by the same work every time at the time of coupling of the fringe generation unit 1 to the semiconductor laser 2.

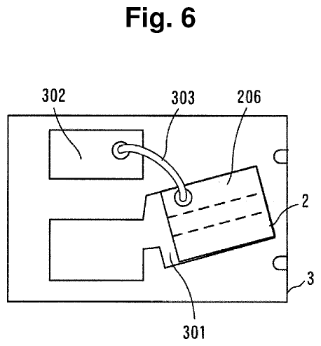

In the present embodiment, the end of the subcarrier 3 is aligned with the exit end of the semiconductor laser 2. The semiconductor laser 2 may be mounted with the exit end of the semiconductor laser 2 inclined at about 8 degrees with respect to the end of the subcarrier 3, as shown in FIG. 6. The semiconductor laser 2 becomes unstable when reflected return light enters. Mounting with the exit end of the semiconductor laser 2 inclined with respect to the end of the subcarrier 3 makes it possible to prevent reflected light from an end face of coupling with the fringe generation unit 1 from returning to the semiconductor laser 2.

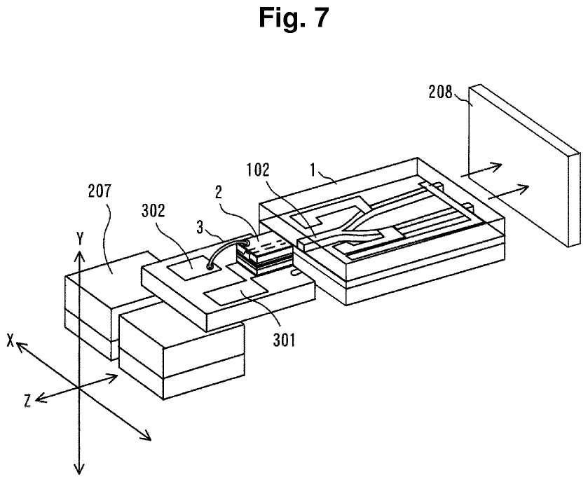

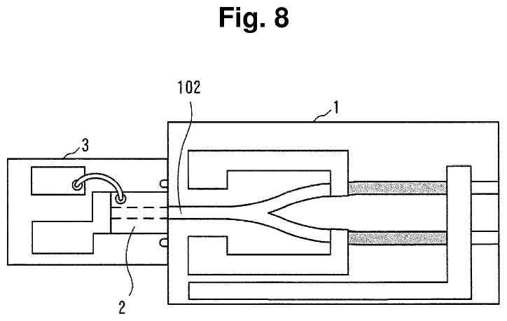

FIG. 7 is a perspective view for explaining a method for coupling the semiconductor laser 2 and the fringe generation unit 1 together, and FIG. 8 is a plan view showing a state where the semiconductor laser 2 and the fringe generation unit 1 are coupled together.

In a state where current is fed to the semiconductor laser 2 via the n-side electrode pad 301 and the p-side electrode pad 302 of the subcarrier 3 and the semiconductor laser 2 is oscillated, the subcarrier 3 is held using a pickup tool 207. The semiconductor laser 2 and the input waveguide 102 of the fringe generation unit 1 are coupled together by an XYZ stage (not shown) having the pickup tool 207 mounted thereon.

In the coupling, a large-sized PD (photodiode) 208 is arranged on an outlet side of the fringe generation unit 1. Alignment of the subcarrier 3 with the fringe generation unit 1 is performed such that light intensity on the exit side of the fringe generation unit 1 is the highest.

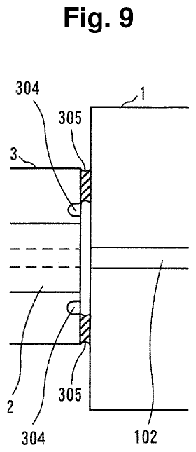

At a position where the light intensity is the highest, a UV (Ultra Violet) adhesive is poured into a gap between the subcarrier 3 and the fringe generation unit 1 from both sides, the UV adhesive is cured through application of UV, and the subcarrier 3 and the fringe generation unit 1 are fixed together. As shown in a plan view in FIG. 9, inflow prevention grooves 304 are formed in an end face of the subcarrier 3. This allows prevention of inflow of an UV adhesive 305 into an end face of the semiconductor laser 2.

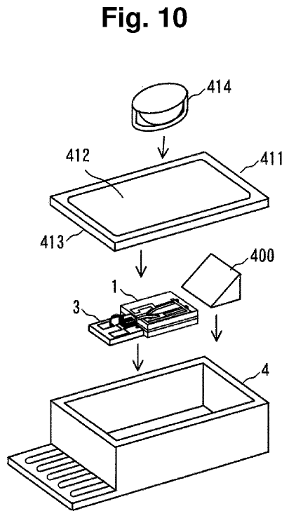

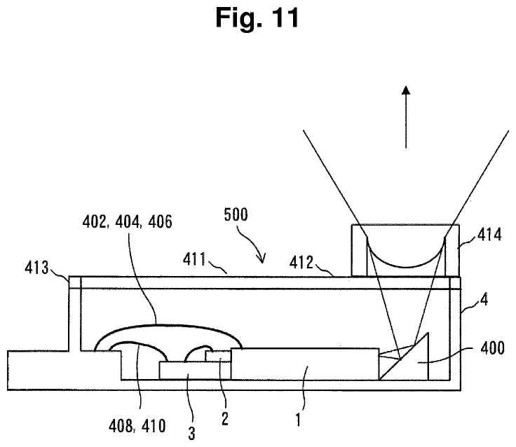

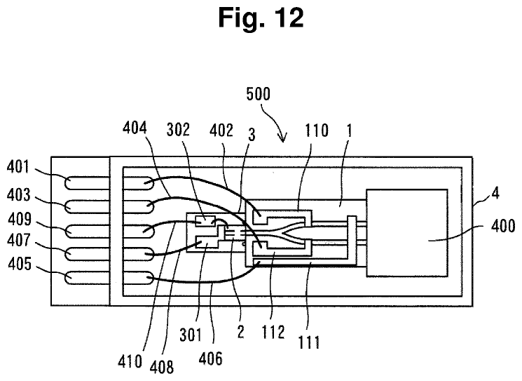

FIG. 10 is a perspective view for explaining a method for fixing the subcarrier 3 and the fringe generation unit 1 to a ceramic housing 4, FIG. 11 is a sectional view showing a state where the subcarrier 3 and the fringe generation unit 1 are housed in the ceramic housing 4, and FIG. 12 is a plan view showing the state where the subcarrier 3 and the fringe generation unit 1 are housed in the ceramic housing 4.

A component in which the subcarrier 3 and the fringe generation unit 1 are connected as described above is housed in the ceramic housing 4. In the ceramic housing 4, a 45-degree prism 400 for implementing 90-degree optical path conversion of outgoing light from the fringe generation unit 1 is housed together with the subcarrier 3 and the fringe generation unit 1.

In housing the subcarrier 3 and the fringe generation unit 1, the 45-degree prism 400 and the fringe generation unit 1 are mechanically arranged in parallel by causing the fringe generation unit 1 to butt against a side of the 45-degree prism 400 fixed to the ceramic housing 4. The subcarrier 3 and the fringe generation unit 1 are fixed to the ceramic housing 4 by the UV adhesive.

After that, the heater pad 110 of the fringe generation unit 1 and an electrode pad 401 of the ceramic housing 4 are connected by a wire 402, the heater pad 112 of the fringe generation unit 1 and an electrode pad 403 of the ceramic housing 4 are connected by a wire 404, and the ground pad 111 of the fringe generation unit 1 and an electrode pad 405 of the ceramic housing 4 are connected by a wire 406.

Additionally, the n-side electrode pad 301 of the subcarrier 3 and an electrode pad 407 of the ceramic housing 4 are connected by a wire 408, and the p-side electrode pad 302 of the subcarrier 3 and an electrode pad 409 of the ceramic housing 4 are connected by a wire 410.

A lid 411 in which a metal frame 413 is formed around a glass 412 by a metallizing method is soldered to the ceramic housing 4 to seal the ceramic housing 4. A sealing surface of the ceramic housing 4 is already subjected to metallization, and metal at the sealing surface and the frame 413 of the lid 411 are soldered together.

After the sealing, a resin-molded lens 414 is arranged on an optical axis of the 45-degree prism 400 and is fixed to the glass 412 of the lid 411 with the IJV adhesive. Although a concave lens obtained by resin injection molding is used as the lens 414, the present disclosure is not limited to this. A ball lens or the like may be adopted. The ceramic housing 4 is set 8 mm long, 2 mm wide, and 1.5 mm thick.

Although the ceramic housing 4 is used in the present embodiment, a housing may be formed of any other material. Although the ceramic housing 4 is sealed to achieve device long-term reliability, housing sealing is not an indispensable constituent feature in the present disclosure.

In some embodiments of the present invention, the 45-degree prism 400 is arranged in order to implement 90-degree optical path conversion of outgoing light from the fringe generation unit 1. However, a method that directly forms a 45-degree mirror at the fringe generation unit 1 may be adopted. In this case, since the 45-degree mirror can be formed by a wafer process, the trouble of arranging 45-degree prisms one by one can be saved, and the number of members can be reduced.

A component assembled by the above-described steps will be called a fringe generation optical module hereinafter. An advantage of the fringe generation optical module is that since the fringe generation optical module is formed using a PLC and has a smaller size than a component which is formed by combining micro-optical components. The fringe generation optical module has the effect of reducing the number of spots to be subjected to an alignment step in members, reducing the number of manufacturing steps, and allowing provision of a low-cost device.

Since a device which modulates an optical phase using, e.g., a piezoelectric element has a movable portion, an optical axis may deviate at the time of transport of the device. In contrast, since the fringe generation optical module according to the present embodiment has no movable portion, optical axis deviation does not occur at the time of transport, and the fringe generation optical module is stable. That is, the fringe generation optical module according to the present embodiment is very small-sized, excellent in portability, and has stability impervious to movement.

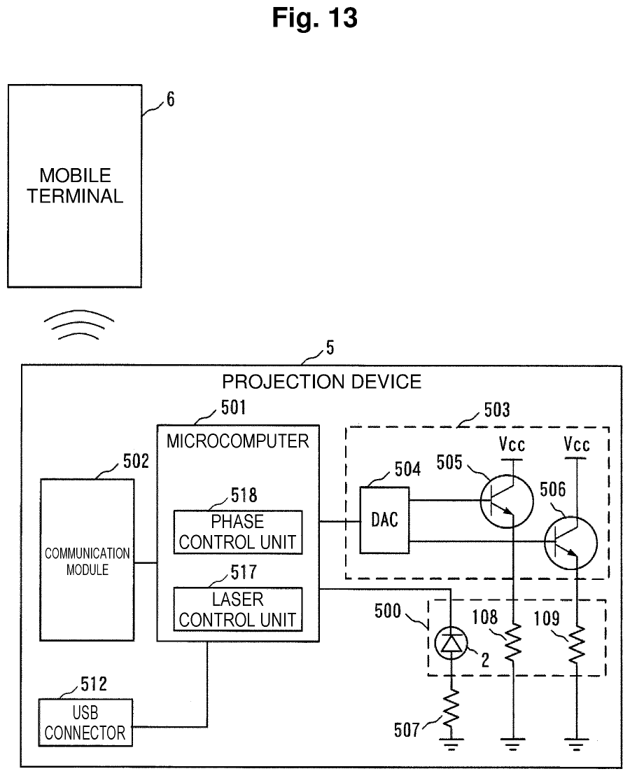

FIG. 13 is a block diagram showing a configuration which controls a fringe generation optical module 500. In a projection device 5 including the fringe generation optical module 500, a microcomputer 501, a communication module 502, a control circuit 503 for the heaters 108 and 109 of the fringe generation optical module 500, and a resistor 507 which is connected to the n-side electrode of the semiconductor laser 2 of the fringe generation optical module 500 are provided.

The control circuit 503 is composed of a DA converter (DAC: Digital to Analog converter) 504, and transistors 505 and 506. With the configuration as in FIG. 13, the microcomputer 501 can drive the heaters 108 and 109 of the fringe generation optical module 500 via the control circuit 503.

Since output power from the DAC 504 is insufficient, the control circuit 503 is configured such that sufficient power can be obtained via the transistors 505 and 506. However, if the output power from the DAC 504 is enough to drive the heaters io8 and 109, the transistors 505 and 506 are unnecessary.

The microcomputer 501 is connected to the communication module 502 so as to be capable of wireless communication with a mobile terminal 6, such as a smartphone. As a wireless communication standard, there is available, for example, Bluetooth®. The microcomputer 501 receives an instruction set from the mobile terminal 6 via the communication module 502.

The microcomputer 501 can control light emission and light turnoff of the semiconductor laser 2 by switching between passing and blocking current to be fed to the semiconductor laser 2 of the fringe generation optical module 500.

The microcomputer 501 executes a process to be described in the present embodiment in accordance with a program stored in an internal memory (not shown) and functions as a laser control unit 517 and a phase control unit 518.

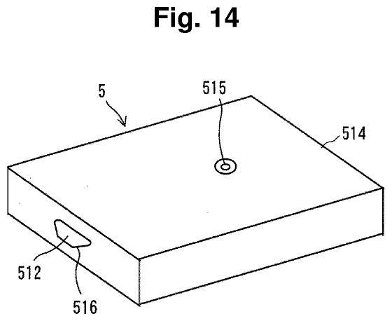

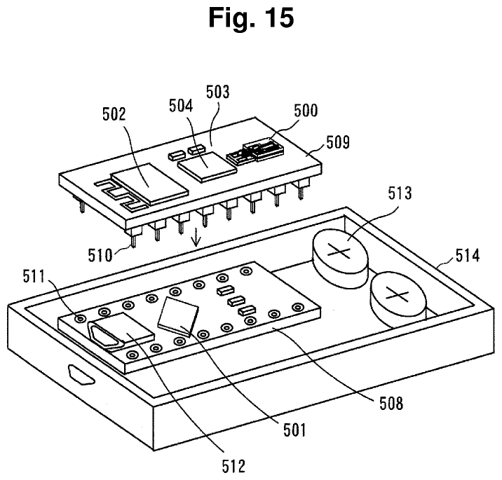

FIG. 14 is a perspective view showing an outer appearance of the projection device 5, and FIG. 15 is an exploded perspective view showing an internal configuration of the projection device 5. In the present embodiment, a printed circuit board 509 is mounted on a commercially available board 508 for the microcomputer 501. The printed circuit board 509 is populated with the fringe generation optical module 500, the communication module 502, and the control circuit 503. As shown in FIG. 15, connector pins 510 which are provided on a lower surface of the printed circuit board 509 are inserted into through-holes 511 of the board 508 and soldered, thereby fixing the printed circuit board 509 and connecting the circuits on the printed circuit board 509 and the circuits on the board 508.

In the present embodiment, the board 501 is also populated with a USB (Universal Serial Bus) connector 512 such that communication with the mobile terminal 6 is possible not only by radio but also by wire. Bluetooth is used for signal exchange with the mobile terminal 6. Any other communication technology, such as Wi-Fi, may be adopted or wired communication using USB may be adopted as long as signal exchange with the mobile terminal 6 is possible.

The board 508 having the printed circuit board 509 mounted thereon and batteries 513 as a power source are housed in a plastic case 514. A size of the plastic case 514 is set at 45 mm×30 mm×5 mm. In the plastic case 514, an exit port 515 is formed such that laser light from the fringe generation optical module 500 can be taken out, and an opening portion 516 which exposes the USB connector 512 is formed.

The exit port 515 is located immediately above the lens 414 of the fringe generation optical module 500. Thus, two light beams which go out from the output waveguides 104 and 105 of the fringe generation unit 1, are reflected by the 45-degree prism 400, and pass through the lens 414 are radiated to the space through the exit port 515.

Note that since power fed from the mobile terminal 6 can be acquired via the USB connector 512 in the case of wired connection, the projection device 5 can be miniaturized, and charging of the batteries 513 and replacement of the batteries 513 are unnecessary.

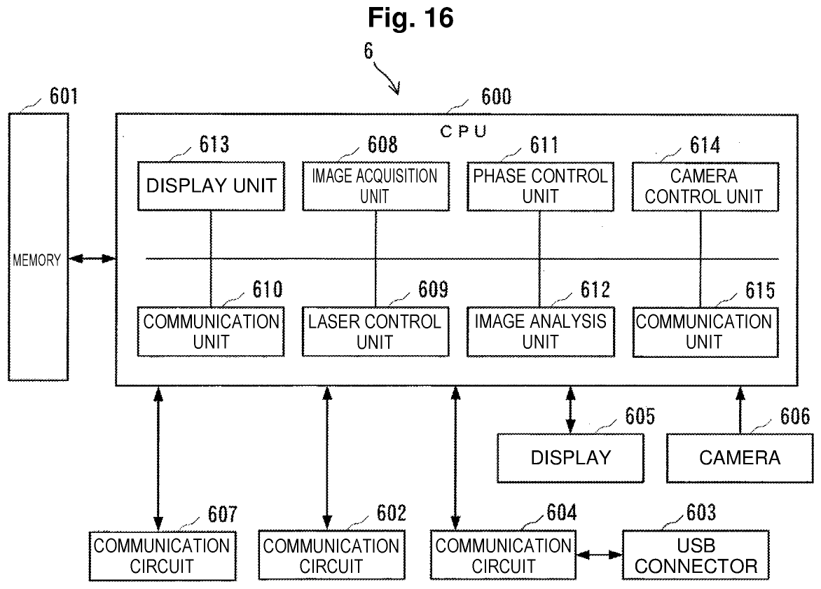

FIG. 16 is a block diagram showing a configuration of the mobile terminal 6. The mobile terminal 6 includes a CPU (Central Processing Unit) 600, a memory 601, a communication circuit 602 for wireless communication with the projection device 5, a USB connector 603 for wired communication, a communication circuit 604 for wired communication, a display 605 with a touch panel function, a camera 606, and a communication circuit 607 for communication with a server device (to be described later).

The CPU 600 executes a process to be described in the present embodiment in accordance with a program stored in the memory 601 and functions as an image acquisition unit 608, a laser control unit 609, a communication unit 610, a phase control unit 611, an image analysis unit 612, a display unit 613, a camera control unit 614, and a communication unit 615.

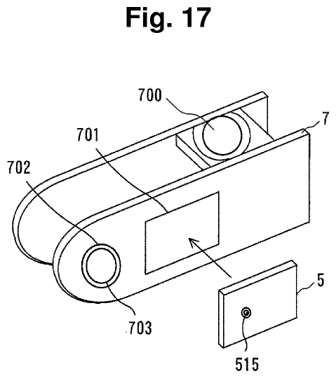

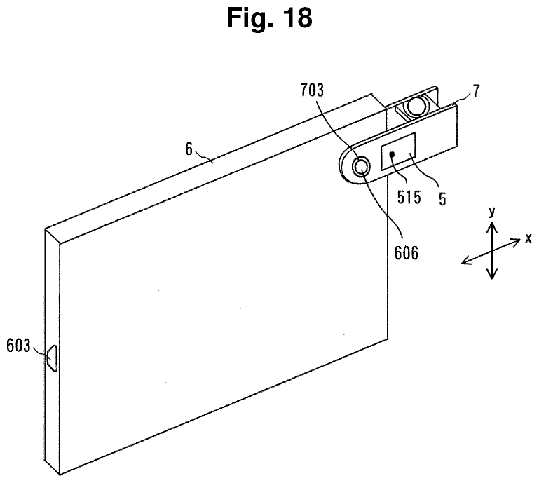

FIGS. 17 and 18 are perspective views for explaining a method for attaching the projection device 5 to the mobile terminal 6. As shown in FIG. 17, the projection device 5 is fixed by fitting the projection device 5 into an opening portion 701 of a clip-shaped fixture 7 having a metal spring 700.

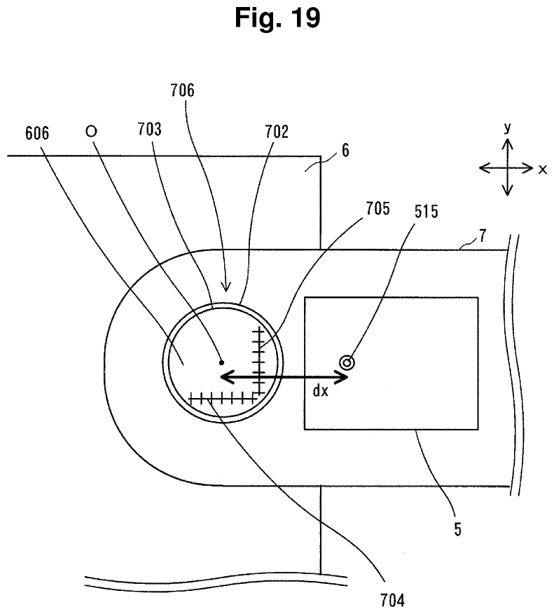

As shown in FIG. 18, the mobile terminal 6 is held by the fixture 7 having the projection device 5 attached thereto. As shown in FIG. 19, a window 703 (a transparent plate) is fit in an opening portion 702 of the fixture 7. A position of the fixture 7 is adjusted such that the window 703 covers a light-receiving surface of the camera 606 of the mobile terminal 6. Reference character O in FIG. 19 denotes a center of the light-receiving surface of the camera 606.

Note that a transparent plate made of an organic substance may be provided instead of the window 703. Although the transparent plate of the organic substance is more easily flawed than glass, the transparent plate allows cost reduction.

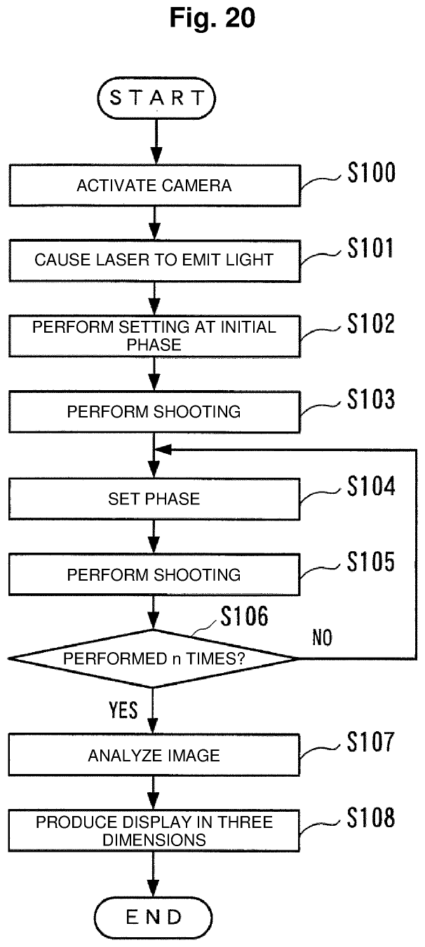

FIG. 20 is a flowchart for explaining a three-dimensional measurement method according to the present embodiment. A user of a three-dimensional measurement system attaches the projection device 5 to the mobile terminal 6 with the fixture 7 in the above-described manner. The projection device 5 is fit in the fixture 7 such that the exit port 515 faces in the same direction as the camera 6 of the mobile terminal 6. It is thus possible to project a fringe pattern from the projection device 5 onto an object to be measured and perform image-taking of the object with the camera 606.

After the user attaches the projection device 5 to the mobile terminal 6, the user activates an application for three-dimensional measurement and points the camera 606 of the mobile terminal 6 at the object to be measured. When the application for three-dimensional measurement is activated, the image acquisition unit 608 of the mobile terminal 6 activates the camera 606 to put the camera 606 in a state allowing image-taking (step S100 of FIG. 20).

The laser control unit 609 of the mobile terminal 6 passes a light emission control signal for turning on the semiconductor laser 2 of the projection device 5 to the communication unit 610. The communication unit 610 passes the light emission control signal to the communication circuit 602 for wireless communication or the communication circuit 604 for wired communication. The communication circuit 602 or 604 transmits the light emission control signal to the projection device 5.

The microcomputer 501 of the projection device 5 receives the light emission control signal from the mobile terminal 6 via the communication module 502. In the case of wired communication, the microcomputer 501 receives the light emission control signal via the USB connector 512. When the laser control unit 517 of the projection device 5 receives the light emission control signal from the mobile terminal 6, the laser control unit 517 causes the semiconductor laser 2 to emit light (step Sim of FIG. 20).

The phase control unit 611 of the mobile terminal 6 passes a phase control signal for setting a phase of a fringe pattern to be projected from the projection device 5 onto the object to be measured at an initial phase to the communication unit 610. The communication unit 610 passes the phase control signal to the communication circuit 602 or 604. The communication circuit 602 or 604 transmits the phase control signal to the projection device 5.

When the phase control unit 518 of the projection device 5 receives the phase control signal from the mobile terminal 6 via the communication module 502 or the USB connector 512, the phase control unit 518 outputs phase control data indicating a voltage value corresponding to the phase control signal to the DAC 504. The DAC 504 outputs a voltage commensurate to the phase control data to the transistors 505 and 5o6. Note that, in the case of the initial phase, a voltage to be applied to the heaters 108 and 109 of the phase modulators 106 and 107 is actually 0. In this manner, the phase of the fringe pattern to be projected from the exit port 515 of the projection device 5 onto the object to be measured can be set at the initial phase (step S102 of FIG. 20).

The image acquisition unit 608 of the mobile terminal 6 acquires an image of the object which is taken by the camera 606. The image of the object is stored in the memory 601 (step S103 of FIG. 20).

After completion of the first image-taking operation, the phase control unit 611 of the mobile terminal 6 passes a phase control signal for shifting the phase of the fringe pattern to be projected onto the object to be measured by π/2 (n is an integer not less than 2) to the communication unit 610.

When the phase control unit 518 of the projection device 5 receives the phase control signal from the mobile terminal 6, the phase control unit 518 outputs phase control data indicating a voltage value corresponding to the phase control signal to the DAC 504. A voltage commensurate to the phase control data is output from the DAC 504 to the transistors 505 and 506, thereby causing the heaters 108 and 109 of the phase modulators 106 and 107 to generate heat. A phase of at least one light ray of light rays propagating through the output waveguides 104 and 105 is phase-modulated by the thermooptical effect. In this manner, the phase of the fringe pattern to be projected from the exit port 515 of the projection device 5 onto the object to be measured can be shifted by t/n (step S1o4 of FIG. 20).

Similarly to the above, the image acquisition unit 608 of the mobile terminal 6 acquires an image of the object which is taken by the camera 606 (step S105 of FIG. 20).

The above-described processes in steps S104 and S105 are performed n times while the phase of the fringe pattern is shifted by π/n each time. In the present embodiment, n is set at 8. It is only required that n be not less than 4. If n is larger, fitting accuracy is higher, and accuracy of three-dimensional measurement of an object can be made higher. Since image-taking takes a longer time, if the mobile terminal 6 is not sufficiently firmly held, a positional deviation may occur.

After n image-taking operations (YES in step Sio6 of FIG. 20), the image analysis unit 612 of the mobile terminal 6 analyzes (n+1) images which are taken by the camera 606 and calculates three-dimensional shape data of the object to be measured (step S107 of FIG. 20). Note that a method for calculating three-dimensional shape data by the phase shift method is a well-known technique and that a detailed description thereof will be omitted.

The display unit 613 of the mobile terminal 6 generates a two-dimensional image obtained by projecting a three-dimensional model of the object which is obtained from the three-dimensional shape data calculated by the image analysis unit 612 onto a projection plane (a screen of the mobile terminal 6) and causes the display 605 to display the generated image (step S108 of FIG. 20). A position of a viewpoint on the three-dimensional model can be freely changed by the user performing, for example, a slide operation on a screen of the display 605 with the touch panel function.

In the present embodiment, the accuracy of three-dimensional measurement of an object is determined by a center of the exit port 515 of the projection device 5 (a center of two light beams radiated from the fringe generation optical module 500 of the projection device 5 to be exact), and a distance dx in an x direction and a distance dy in a y direction from the center O of the light-receiving surface of the camera 606. A case where the projection device 5 is attached to the mobile terminal 6 using the clip-shaped fixture 7 as described above suffers a situation where the distances dx and dy are hard to uniquely determine.

For the above-described reasons, respective scales 704 and 705 in two directions (the x direction and the y direction in FIGS. 18 and 19) orthogonal to an image-taking direction of the camera 606 are formed on the window 703 of the fixture 7. The window 703 (the transparent plate) and the scales 704 and 705 constitute an alignment structure 706 for determining a position of the exit port 515 of the projection device 5 relative to the camera 606 of the mobile terminal 6.

In the present embodiment, the intervals between tick marks of the scale 704 and between tick marks of the scale 705 are set at 500 μm. Although the scales 704 and 705 are printed on the window 703 using screen printing technology, the scales 704 and 705 may be formed by another method, such as laser processing.

An effect of the alignment structure 706 according to the present embodiment will be described. The user adjusts the position of the fixture 7 such that a center position of the window 703 of the fixture 7 is located at a position generally at the center of the light-receiving surface of the camera 606 of the mobile terminal 6. This makes it possible to set the distances dx and dy between the center of the exit port 515 of the projection device 5 and the center of the light-receiving surface of the camera 606 generally close to desired values and allows more accurate three-dimensional measurement.

At the time of image-taking of an object with the camera 606 of the mobile terminal 6, the scales 704 and 705 on the glass appear in an image though the scales 704 and 705 are out of focus. As described above, the user adjusts an attachment position of the fixture 7. Since the user performs manual adjustment, an error in alignment is large.

However, since the scales 704 and 705 appear in an image taken by the camera 606, the user can know the distances dx and dy on the basis of the scales 704 and 705 in the image. As a result, the distances dx and dy can be exactly known, and the accuracy of three-dimensional measurement can be increased.

Note that the more accurate distances dx and dy may be grasped by not using appearance in image-taking of the object but performing image-taking of only the scales 704 and 705 formed on the window 703 once beforehand.

### Second Embodiment

A second embodiment of the present invention will be described. The first embodiment has described a mode in which the projection device 5 is attached to the mobile terminal 6 using the clip-shaped fixture 7. The mode, however, suffers a situation where the distances dx and dy between the center of the exit port 515 of the projection device 5 and the center of the light-receiving surface of the camera 606 vary with each attachment operation.

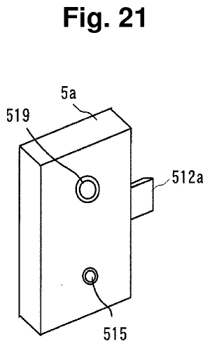

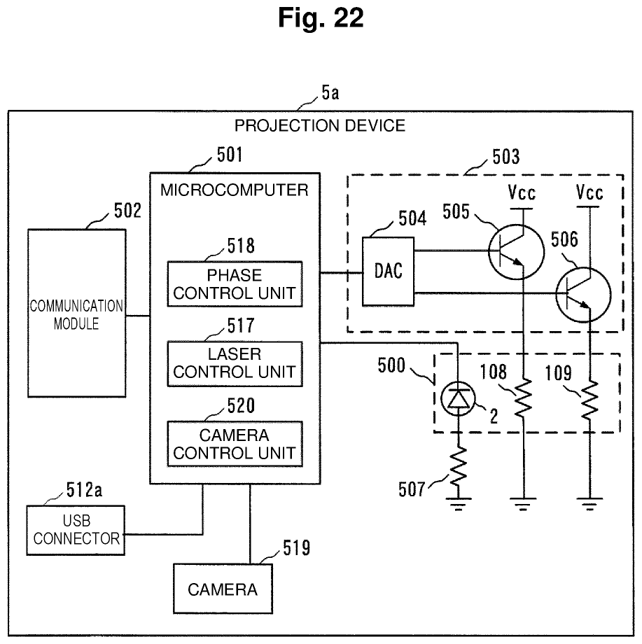

For the above-described reason, a camera may be mounted on a projection device. An outer appearance of a projection device 5a in this case is shown in FIG. 21, and a configuration of the projection device 5a is shown in FIG. 22.

A microcomputer 501 of the projection device 5a executes a process to be described in the present embodiment in accordance with a program stored in an internal memory (not shown) and functions as a laser control unit 517, a phase control unit 518, and a camera control unit 520 which controls a camera 519.

As can be seen from FIGS. 14 and 15, the projection device 5 according to the first embodiment is based on the assumption that a USB cable is used for wired connection to the mobile terminal 6. For this reason, the USB connector 512 of the projection device 5 is a female connector.

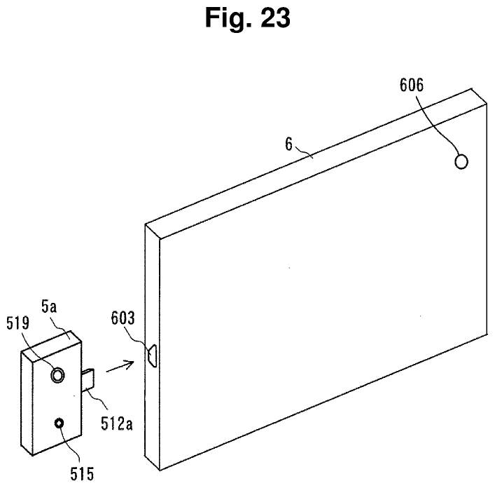

In contrast, in the case of the projection device 5a according to the present embodiment, the projection device 5a is used in a state where a male USB connector 512a (a first connector) is inserted into a USB connector 603 (a second connector) of a mobile terminal 6, as shown in FIG. 23. That is, in the present embodiment, signal exchange between the projection device 5a and the mobile terminal 6 is performed by wired communication.

A configuration of the mobile terminal 6 is the same as in the first embodiment.

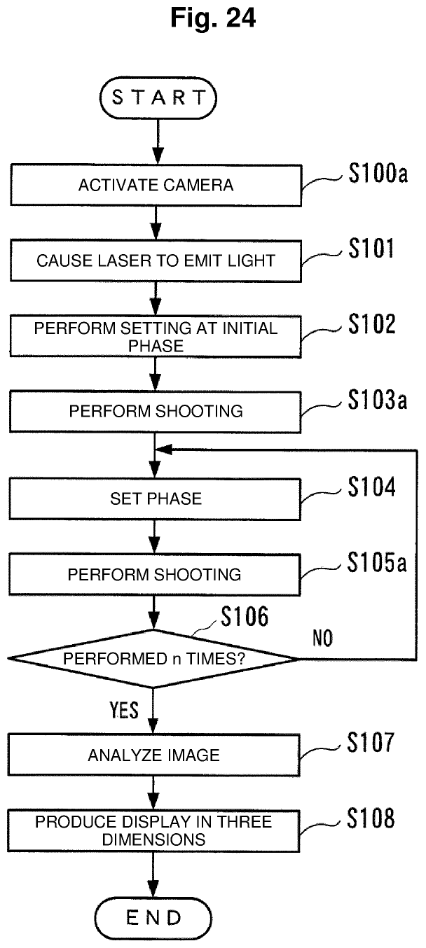

FIG. 24 is a flowchart for explaining a three-dimensional measurement method according to the present embodiment. After a user attaches the projection device 5a to the mobile terminal 6, the user activates an application for three-dimensional measurement and points the camera 519 of the projection device 5a at an object to be measured. When the application for three-dimensional measurement is activated, a camera control unit 614 of the mobile terminal 6 passes a camera activation control signal to a communication unit 610. The communication unit 610 passes the camera activation control signal to a communication circuit 604 for wired communication. The communication circuit 604 transmits the camera activation control signal to the projection device 5a.

When the camera control unit 520 of the projection device 5a receives the camera activation control signal via the USB connector 512a, the camera control unit 520 activates the camera 519 and puts the camera 519 in a state allowing image-taking (step S100a of FIG. 24).

Processes in steps S101 and S102 of FIG. 24 are the same as in the first embodiment. An image acquisition unit 608 of the mobile terminal 6 passes an image request signal to the communication unit 610. The communication unit 610 passes the image request signal to the communication circuit 604. The communication circuit 604 transmits the image request signal to the projection device 5a.

When the camera control unit 520 of the projection device 5a receives the image request signal via the USB connector 512a, the camera control unit 520 transmits an image of the object which is taken by the camera 519 to the mobile terminal 6 via the USB connector 512a.

The image acquisition unit 608 of the mobile terminal 6 acquires the image transmitted from the projection device 5a (step S103a of FIG. 24).

Processes in steps S104 and S106 to S108 of FIG. 24 are the same as in the first embodiment. A process in step Sio5a of FIG. 24 is the same as in step S103a.

In the above-described manner, in the present embodiment, three-dimensional measurement of an object can be performed using the dedicated camera 519 of the projection device 5a. In the present embodiment, a distance between a center of an exit port 515 and a center of a light-receiving surface of the camera 519 can be kept constant. Thus, high-accuracy three-dimensional measurement is possible.

Note that, since the camera 519 is mounted on the projection device 5a, separately from a camera 606 which is included as standard equipment in the mobile terminal 6, the present embodiment has the disadvantage of cost increase.

Note that a dimensional error at the time of manufacture can be grasped by preliminary inspection. It is thus possible to correct an error by setting a correction value based on a grasped error in a program of an image analysis unit 612 of the mobile terminal 6.

### Third Embodiment

In the first and second embodiments, analysis of a picked-up image is performed by the image analysis unit 612 of the mobile terminal 6, and three-dimensional shape data of an object is calculated.

In contrast, image-taken image data and measurement conditions may be transmitted to a dedicated server device, three-dimensional shape data of an object may be calculated by the server device, and a calculation result may be sent back to the mobile terminal 6.

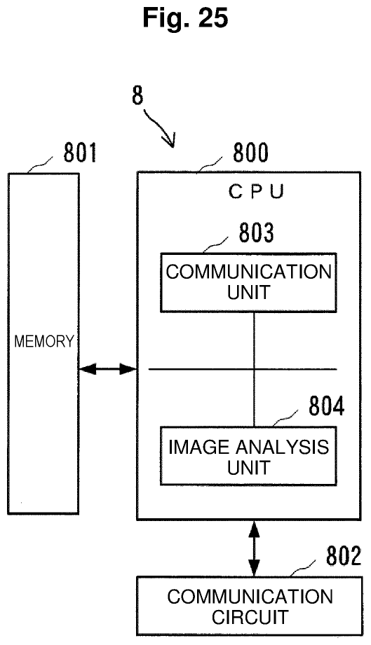

A configuration of a server device according to the present embodiment is shown in FIG. 25. A server device 8 includes a CPU 800, a memory 801, and a communication circuit 802 for wireless communication. The CPU 800 executes a process to be described in the present embodiment in accordance with a program stored in the memory 801 and functions as a communication unit 803 and an image analysis unit 804.

Configurations of a projection device 5 or 5a and a mobile terminal 6 are the same as in the first or second embodiment.

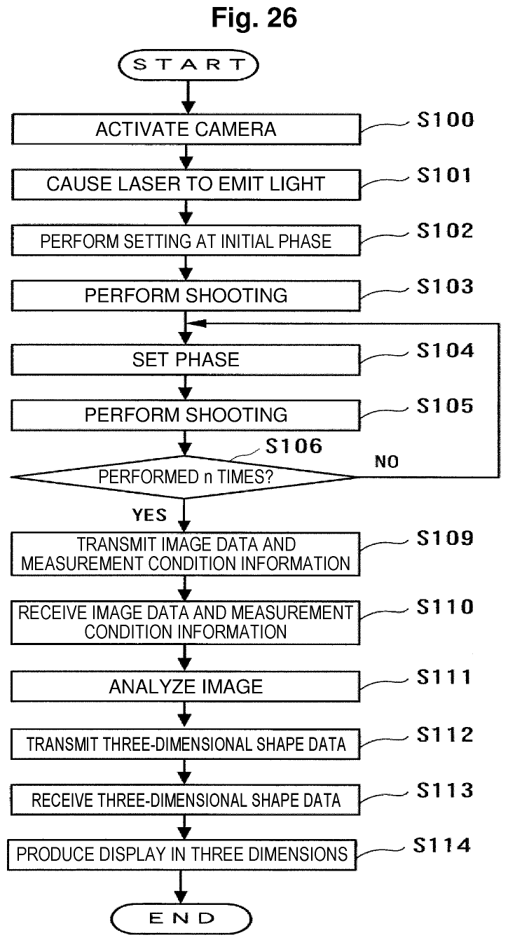

FIG. 26 is a flowchart for explaining a three-dimensional measurement method according to the present embodiment. Processes in steps S100 to S106 of FIG. 26 are the same as in the first embodiment.

A communication unit 615 of the mobile terminal 6 passes image data of an image-taken object and measurement condition information (e.g., phase information of a fringe pattern) to a communication circuit 607. The communication circuit 607 wirelessly transmits the image data and the measurement condition information to the server device 8 (step S109 of FIG. 26).

The communication unit 803 of the server device 8 passes, to the image analysis unit 804, the image data and the measurement condition information received from the mobile terminal 6 via the communication circuit 802 (step S110 of FIG. 26).

The image analysis unit 804 analyzes a received image and calculates three-dimensional shape data of the object to be measured (step S111 of FIG. 20). Processing of the image analysis unit 804 is the same as processing of the image analysis unit 612 of the mobile terminal 6.

The communication unit 803 of the server device 8 passes the three-dimensional shape data calculated by the image analysis unit 804 to the communication circuit 802. The communication circuit 802 transmits the three-dimensional shape data to the mobile terminal 6 (step S112 of FIG. 26).

The communication unit 615 of the mobile terminal 6 passes, to a display unit 613, the three-dimensional shape data received from the server device 8 via the communication circuit 607 (step S113 of FIG. 26). The display unit 613 causes a display 605 to display the image of the object, as described above (step S114 of FIG. 26).

Although the description of FIG. 26 describes a case where the server device 8 according to the present embodiment is applied to the first embodiment, the server device 8 may, of course, be applied to the second embodiment.

In a case where the server device 8 is used as in the present embodiment, if a sufficient communication speed between the mobile terminal 6 and the server device 8 is obtained, processing of the mobile terminal 6 can be reduced, and power consumption of the mobile terminal 6 can be reduced. As a result, a battery of the mobile terminal 6 can be inhibited from being exhausted.

In the present embodiment, it is possible to send three-dimensional shape data acquired by the projection device 5 or 5a and the mobile terminal 6 from the server device 8 to another terminal. Thus, the present embodiment has the advantage that sharing of three-dimensional shape data with another terminal is easy.

### Fourth Embodiment

A fourth embodiment of the present invention will be described. In the fringe generation unit 1 described in the first to third embodiments, a light source composed of the semiconductor laser 2, the input waveguide 102, the Y branching waveguide 103, the phase modulators 106 and 107, and the output waveguides 104 and 105 are arranged on a generally straight line.

For the above-described reason, when outgoing light from the semiconductor laser 2 is coupled to the input waveguide 102 composed of a quartz-based light waveguide, a coupling loss occurs due to a mode field mismatch. In the case of the first embodiment, a coupling loss is, for example, about 2.5 dB, and about a little less than half of light radiates without being coupled to the input waveguide 102 and becomes stray light.

In the first to third embodiments, a fringe pattern, intensity of which is modulated in a spatially sinusoidal manner by interference between two light beams going out from the output waveguides 104 and 105, is obtained. However, when stray light arrives at the exit port 515 of the projection device 5 or 5a and is emitted from the exit port 515 to a space, unexpected interference between the fringe pattern and the stray light occurs. This increases an error in calculation of three-dimensional shape data of an object.

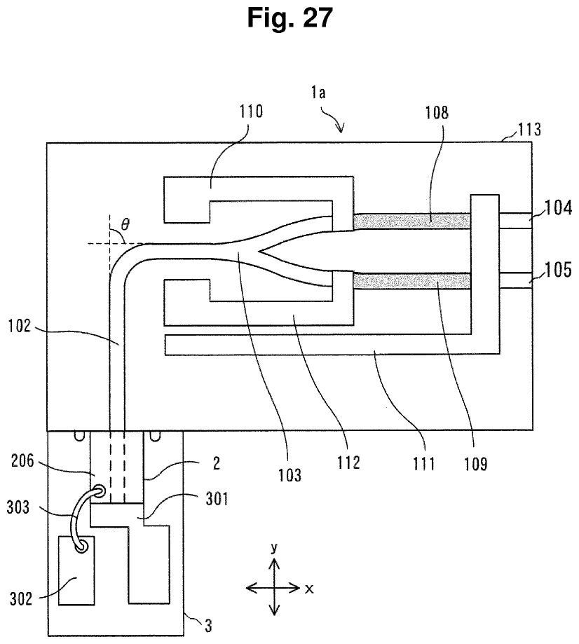

Under the circumstances, a fringe generation unit 1a according to the present embodiment is structured such that an input waveguide 102 is bent in a plane of a silicon substrate such that a direction of incidence of light from a semiconductor laser 2 to an input waveguide 102 (a y direction in FIG. 27) and a direction of emergence of light from output waveguides 104 and 105 (an x direction in FIG. 27) intersect, as shown in FIG. 27.

In the present embodiment, designing and manufacturing are performed with a relative refractive index difference for a light waveguide set at 1% and a bend radius of the input waveguide 102 set at 1 mm. A manufacturing method for the fringe generation unit la, a method for coupling to the semiconductor laser 2, and a method for modularizing the fringe generation unit 1a and the semiconductor laser 2 are the same as in the first embodiment.

Since the direction of incidence of light from the semiconductor laser 2 to the input waveguide 102 and the direction of emergence of light from the output waveguides 104 and 105 are made to intersect in the present embodiment, stray light generated as a coupling loss due to a mode field mismatch at the time of coupling outgoing light from the semiconductor laser 2 to the input waveguide 102 composed of a quartz-based light waveguide hardly goes out from the output waveguides 104 and 105. For this reason, when two light beams are emitted from a projection device to a space, a sinusoidally modulated fringe pattern can be obtained.

In the present embodiment, the fringe generation unit 1a is formed such that the direction of incidence of light from the semiconductor laser 2 to the input waveguide 102 is orthogonal to the direction of emergence of light from the output waveguides 104 and 105. Depending on a size of a chip including a quartz-based light waveguide, if an angle θ of inclination of the direction of emergence of light from the output waveguides 104 and 105 with respect to the direction of incidence of light from the semiconductor laser 2 to the input waveguide 102 is generally not less than 30 degrees, stray light does not go out from the output waveguides 104 and 105, and a fringe pattern which is ideally and sinusoidally modulated can be obtained.

Although examples where a light waveguide is used to generate a fringe pattern have been conventionally proposed, an optical fiber is used in any example.

The inventor has found out for the first time that, in a configuration which obtains a fringe pattern, intensity of which is modulated in a spatially sinusoidal manner by interference between two light beams, when stray light is emitted from an exit port of an output waveguide to a space, an unexpected light and dark pattern is superimposed on an original fringe pattern as a result, and accuracy of three-dimensional measurement by a phase shift method decreases.

The inventor has also found out for the first time that a close-to-ideal fringe pattern, intensity of which changes sinusoidally, is obtained by causing a direction of incidence of light from a semiconductor laser to an input waveguide and a direction of emergence of light from an output waveguide to intersect, as described above.

### INDUSTRIAL APPLICABILITY

The embodiments of the present invention can be applied to a technique for measuring a three-dimensional shape of an object by a phase shift method.

### REFERENCE SIGNS LIST

1, 1a Fringe generation unit

2 Semiconductor laser

3 Subcarrier

4 Ceramic housing

5, 5a Projection device

6 Mobile terminal

7 Fixture

8 Server device

100 Silicon substrate

101 Undercladding

102 Input waveguide

103 Y branching waveguide

104, 105 Output waveguide

106, 107 Phase modulator

108, 109 Heater

110, 112 Heater pad

111 Ground pad

113 Overcladding

114 Heat-insulating groove

115 Light-shielding groove

200 n-type GaAs substrate

201 n-type AlGaInP cladding

202 Active layer

203 p-type AlGaInP cladding layer

204 n-type AlInP block layer

205 n-side electrode

206 p-side electrode

300 Silicon substrate

301 n-side electrode pad

302 p-side electrode pad

303 Wire

400 45-degree prism

401, 403, 405, 407, 409 Electrode pad

402, 404, 406, 408, 410 Wire

411 Lid

412 Glass

413 Frame

414 Lens

500 Fringe generation optical module

501 Microcomputer

502 Communication module

503 Control circuit

504 DA converter

505, 506 Transistor

508 Board

509 Printed circuit board

510 Pin

511 Through-hole

512, 512a USB connector

513 Battery

514 Plastic case

515 Exit port

517 Laser control unit

518 Phase control unit

519, 606 Camera

520 Camera control unit

600, 800 CPU

601, 801 Memory

602, 604, 607, 802 Communication circuit

603 USB connector

605 Display

606 Camera

608 Image acquisition unit

609 Laser control unit

610, 615, 803 Communication unit

611 Phase control unit

612, 804 Image analysis unit

613 Display unit

614 Camera control unit

703 Window

704, 705 Scale

706 Alignment structure

1.-8. (canceled)

9. A three-dimensional measurement system comprising:
a projection device configured to generate a fringe pattern by interference between two light beams and project the fringe pattern onto an object; and
a mobile terminal,
wherein the projection device includes:
a fringe generation unit composed of a planar lightwave circuit including a phase modulator, the fringe generation unit being configured to generate the fringe pattern, and
a phase control unit configured to control the phase modulator and change a phase of the fringe pattern,
wherein the mobile terminal includes:
a camera configured to perform image-taking of the object, the fringe pattern being projected onto the object, and
an image analysis unit configured to analyze a plurality of images which are taken by the camera and are different in the phase of the fringe pattern and calculate three-dimensional shape data of the object.

10. The three-dimensional measurement system according to claim 9, wherein the fringe generation unit includes:
a light source,
an input waveguide coupled to an output of the light source,
a Y-branching waveguide connected to the input waveguide, the Y-branching waveguide being configured to branch light into two,
two output waveguides connected to respective outputs of the Y-branching waveguide, and
two phase modulators, each phase modulator being identical to the phase modulator, the two phase modulators being provided at the two output waveguides respectively, the two phase modulators being configured to modulate phases of light rays propagating through the two output waveguides.

11. The three-dimensional measurement system according to claim 10, wherein the input waveguide is bent in a middle such that an angle of inclination of a direction of emergence of light from the output waveguides with respect to a direction of incidence of light from the light source to the input waveguide is not less than 30 degrees.

12. The three-dimensional measurement system according to claim 9, further comprising:
a clip-shaped fixture that holds the mobile terminal, wherein the projection device is fixed to the clip-shaped fixture, and the clip-shaped fixture includes an alignment structure for determining a position of an exit port for the two light beams of the projection device relative to the camera of the mobile terminal.

13. The three-dimensional measurement system according to claim 12, wherein the alignment structure comprises:
a transparent plate disposed at the clip-shaped fixture so as to cover a light-receiving surface of the camera of the mobile terminal when the clip-shaped fixture is attached to the mobile terminal; and
a scale formed on the transparent plate.

14. The three-dimensional measurement system according to claim 9, wherein the projection device includes further comprises:
a first communication unit configured to transmit an image taken by the camera to the mobile terminal; and
a first connector for communication with the mobile terminal.

15. The three-dimensional measurement system according to claim 14, wherein the mobile terminal further comprises:
a second communication unit configured to receive the image from the projection device; and
a second connector for communication with the projection device, the projection device being attached to the mobile terminal by fitting together of the first connector and the second connector.

16. A three-dimensional measurement system comprising:
a projection device configured to generate a fringe pattern by interference between two light beams and project the fringe pattern onto an object; and
a mobile terminal,
wherein the projection device includes:
a fringe generation unit composed of a planar lightwave circuit including a phase modulator, the fringe generation unit being configured to generate the fringe pattern,
a phase control unit configured to control the phase modulator and change a phase of the fringe pattern,
a camera configured to perform image-taking of the object, the fringe pattern being projected onto the object,
a first communication unit configured to transmit an image taken by the camera to the mobile terminal, and
a first connector for communication with the mobile terminal,
wherein the mobile terminal includes:
a second communication unit configured to receive the image from the projection device,
an image analysis unit configured to analyze a plurality of images which are taken by the camera of the projection device and are different in the phase of the fringe pattern and calculate three-dimensional shape data of the object, and
a second connector for communication with the projection device, the projection device being attached to the mobile terminal by fitting together of the first connector and the second connector.

17. The three-dimensional measurement system according to claim 16, wherein the fringe generation unit includes:
a light source,
an input waveguide coupled to an output of the light source,
a Y branching waveguide connected to the input waveguide, the Y branching waveguide being configured to branch light into two,
two output waveguides connected to respective outputs of the Y branching waveguide, and
two phase modulators, each phase modulator being identical to the phase modulator, the two phase modulators being provided at the two output waveguides respectively, the two phase modulators being configured to modulate phases of light rays propagating through the two output waveguides.

18. The three-dimensional measurement system according to claim 17, wherein
the input waveguide is bent in a middle such that an angle of inclination of a direction of emergence of light from the output waveguides with respect to a direction of incidence of light from the light source to the input waveguide is not less than 30 degrees.
